(19) United States
(12) Patent Application Publication
(10) Pub. No.: US 2017/0322935 A1
(43) Pub. Date: Nov. 9, 2017

(54) AUTOMATED/SMART CREATION DISPLAY OF VEHICLE IDENTIFICATION NUMBER AND OTHER OWNER INFORMATION VIA INFOTAINMENT DISPLAY

(71) Applicant: Panasonic Automotive Systems Company of America, Division of Panasonic Corporation of North America, Peachtree City, GA (US)

(72) Inventor: SAURIN DESAI, SUWANEE, GA (US)

(21) Appl. No.: 15/586,885

(22) Filed: May 4, 2017

Related U.S. Application Data
(60) Provisional application No. 62/332,735, filed on May 6, 2016.

(51) Int. Cl. G06F 17/30; B60R 11/02; G08G 1/017; B60K 37/06

(52) U.S. Cl. CPC G06F 17/30029; G08G 1/017; B60K 37/06; B60R 11/0229; G06F 17/30038

(57) ABSTRACT

A vehicle includes a memory device storing information identifying the vehicle. An infotainment user interface includes a display screen, a keyboard, and an electronic processing device communicatively coupled to the memory device. The electronic processing device responds to a user keying in a set of predefined characters into the keyboard by displaying on the display screen the information identifying the vehicle.

### CROSS-REFERENCE TO RELATED APPLICATION

This application claims benefit of U.S. Provisional Application No. 62/332,735 filed on May 6, 2016, which the disclosure of which is hereby incorporated by reference in its entirety for all purposes.

### FIELD OF THE INVENTION

The disclosure relates to the field of display systems, and, more particularly, to display systems installed in motor vehicles.

### BACKGROUND OF THE INVENTION

Currently, automotive infotainment systems do not hold any vehicle identification information.

### SUMMARY

In the future, vehicles with more connectivity will require a unique attribute for identification and connectivity purposes. The inventive smart user interaction arrangement shall be very helpful in such a scenario, The invention may make vehicle identification number (VIN) information available in the car using the human machine interface (HMI). Particularly, the invention may make VIN information available via the vehicle's infotainment system.

In one embodiment, the invention comprises a vehicle including a memory device storing information identifying the vehicle. An infotainment user interface includes a display screen, a keyboard (a virtual keyboard in some cases), and an electronic processing device communicatively coupled to the memory device. The electronic processing device responds to a user keying in a set of predefined characters into the keyboard by displaying on the display screen the information identifying the vehicle.

In another embodiment, the invention comprises a method of operating an infotainment system of a vehicle, including storing information identifying the vehicle in a memory device. An infotainment user interface is provided, including a display screen, a keyboard, and an electronic processing device. The electronic processing device is communicatively coupled to the memory device. A response to a user keying in a set of predefined characters into the keyboard includes displaying on the display screen the information identifying the vehicle.

In yet another embodiment, the invention includes a method of operating an infotainment system of a vehicle, including displaying a list of active shortcuts on a display screen of an infotainment user interface. Each active shortcut defines an item of information to be displayed on the display screen in response to a user identifying the active shortcut. Each item of information is stored in a memory device. The user is prompted to indicate whether he would like to create an additional active shortcut. If the user indicates that he would like to create an additional active shortcut, then a list of inactive shortcuts is displayed. Each inactive shortcut is displayed in association with a corresponding item of information to be provided by the user, if the user indicates that he would not like to create an additional active shortcut, then the user is informed how he may create an additional active shortcut at a future time.

An advantage of the invention is that it may provide vehicle owners/drivers/mechanics/OEM dealerships/first responders, etc., with easy access to the vehicle identification number and other information.

### BRIEF DESCRIPTION OF THE DRAWINGS

A better understanding of the present invention will be had upon reference to the following description in conjunction with the accompanying drawings.

FIG. 1 is a block diagram of one embodiment of an automotive infotainment arrangement of the present invention.

FIG. 2 is a flow chart of one embodiment of a method of the present invention for operating an automotive infotainment arrangement.

FIG. 3 is a flow chart of another embodiment of a method of the present invention for operating an infotainment system of a vehicle.

FIG. 4 is a flow chart of yet another embodiment of a method of the present invention for operating an infotainment system of a vehicle.

### DETAILED DESCRIPTION OF THE PREFERRED EMBODIMENTS

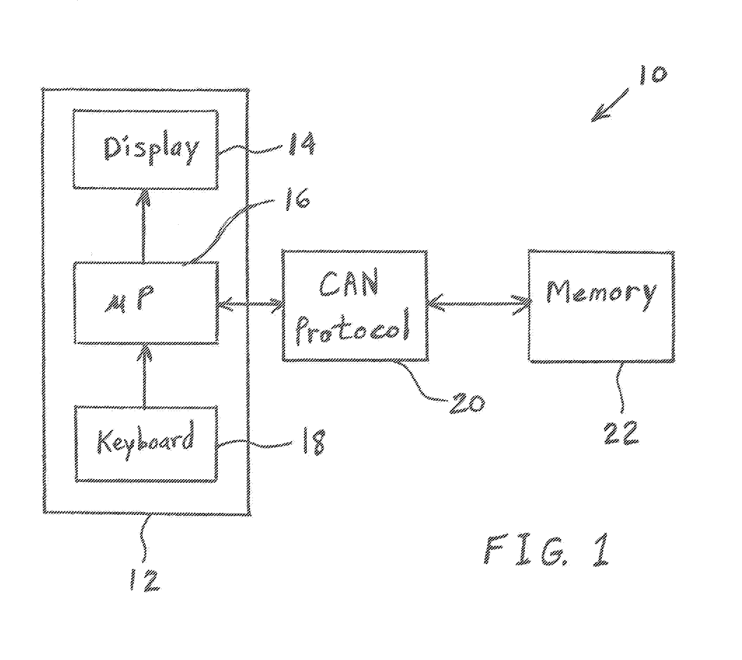

FIG. 1 illustrates one embodiment of an automotive infotainment arrangement 10 of the present invention including an infotainment user interface 12 having a display screen 14, an electronic processor 16, and a keyboard 18. Processor 16 is in bi-directional communication with a controller area network (CAN) protocol 20, which, in turn, is in bi-directional communication with a memory device 22.

In one embodiment of a method of the present invention for operating an automotive infotainment arrangement, the infotainment system hardware is in a power-ON state. The user may type “myVIN” (e.g., any combination of upper and lower case letters without a space between the words “my” and “VIN”) while on any display screen on the in-vehicle infotainment (IVI) interface. After the user has depressed the SPACE, TAB or ENTER key on the IVI interface, the smart engine shall populate the display screen of the interface with the actual vehicle identification number. In order to display the VIN, the HMI software may query CAN protocol 20 and retrieve that information, and the VIN number may be displayed to the user on the screen.

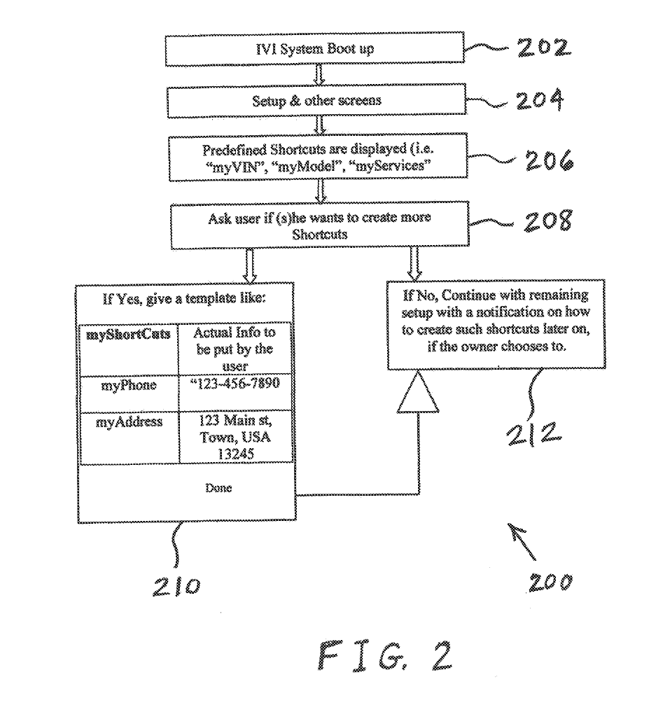

FIG. 2 illustrates one embodiment of a method 200 of the present invention for operating an automotive infotainment arrangement. In a first step 202, the in-vehicle infotainment (IVI) interface is booted up. The boot up of the in-vehicle infotainment (IVI) interface may occur automatically upon engine ignition. In a next step 204, a system setup screen is displayed, and other menu options may be presented on the display screen. Next, in step 206, predefined shortcuts are presented on the display screen, such as “myVIN”, which may display the vehicle's identification number; “myModel”, which may display the vehicle's model name; and “myServices”, which may display the online services that the vehicle has subscriptions for, such as Sirius, OnStar, etc. In step 208, the user may be asked via on-screen text whether he wants to create additional shortcuts. If the user indicates that he does want to create an additional shortcut, then in step 210 a template may be presented to the user on the display screen. The template may present a list of shortcut names and the corresponding information that would need to be input into the system by the user, either orally, by keying in the characters, or by uploading from the user's mobile telephone. After the user has selected one or more shortcuts to create, and has entered the corresponding content, operation proceeds to step 212 wherein the system may continue with its remaining setup, and may notify the user how he may create an additional shortcut at a later time if he wants to. For example, the user may be informed of two separate pushbuttons that may be pressed simultaneously in order to bring up the template of step 210. If, in response to step 208, the user indicates that he does not want to create an additional shortcut, then operation may proceed directly to step 212.

In addition to the vehicle identification number, the invention may be implemented to make other information available for easy display to the user via shortcuts.

A similar mechanism may access more information from the vehicle and such shortcuts, and may make access to driver/owner easy. For example, a “myCar” shortcut may present several lines identifying the vehicle, including the VIN, model, make, model year, engine size, whether the vehicle is front wheel drive, rear wheel drive, or all-wheel drive, and any other features that may vary from vehicle to vehicle.

During use, persistent memory device 22 may store in the IVI system the owner-entered information, and this information can be retrieved from memory device 22. The information may include, for example, “myHome”, which may display the identity of the dealership that originally sold the vehicle; “myLicense”, which may display the vehicle's current license plate number and renewal date; and “myServiceRecord”, which may display information pertaining to maintenance services which have been performed on the vehicle. Thus, this service record can easily be made accessible to the vehicle owner as well as to dealerships and service technicians.

In one embodiment, all the possible predefined and user-created smart tags do not include any space between the words “my” and “abcd . . . ”, where abcd represents the tag of the service.

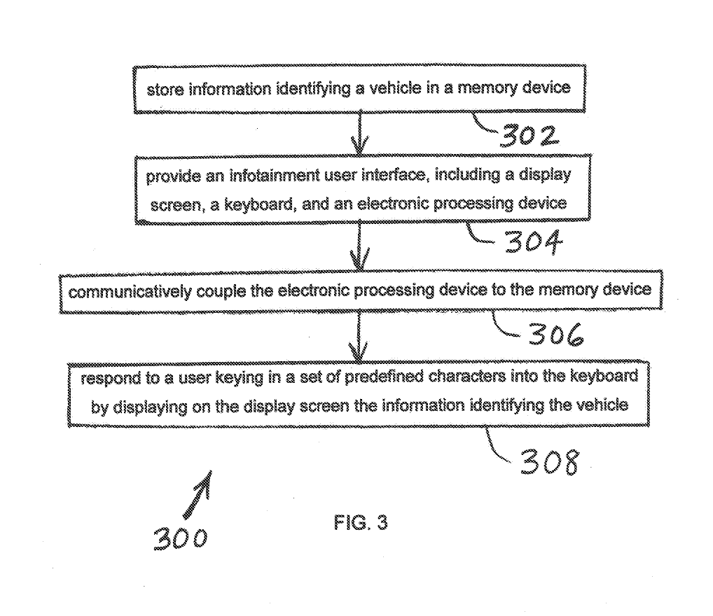

FIG. 3 illustrates another embodiment of a method 300 of the present invention for operating an infotainment system of a vehicle. In a first step 302, information identifying the vehicle is stored in a memory device. For example, the vehicle identification number may be stored in memory device 22.

Next, in step 304, an infotainment user interface is provided. The infotainment user interface includes a display screen, a keyboard, and an electronic processing device. For example, infotainment user interface 12 has a display screen 14, an electronic processor 16, and a keyboard 18.

In a next step 306, the electronic processing device is communicatively coupled to the memory device. For example, electronic processor 16 may be in bi-directional communication with memory device 22.

In a final step 308, a user keying in a set of predefined characters into the keyboard is responded to by displaying on the display screen the information identifying the vehicle. For example, if the user types in “myvin”, display screen 14 may display the actual vehicle identification number.

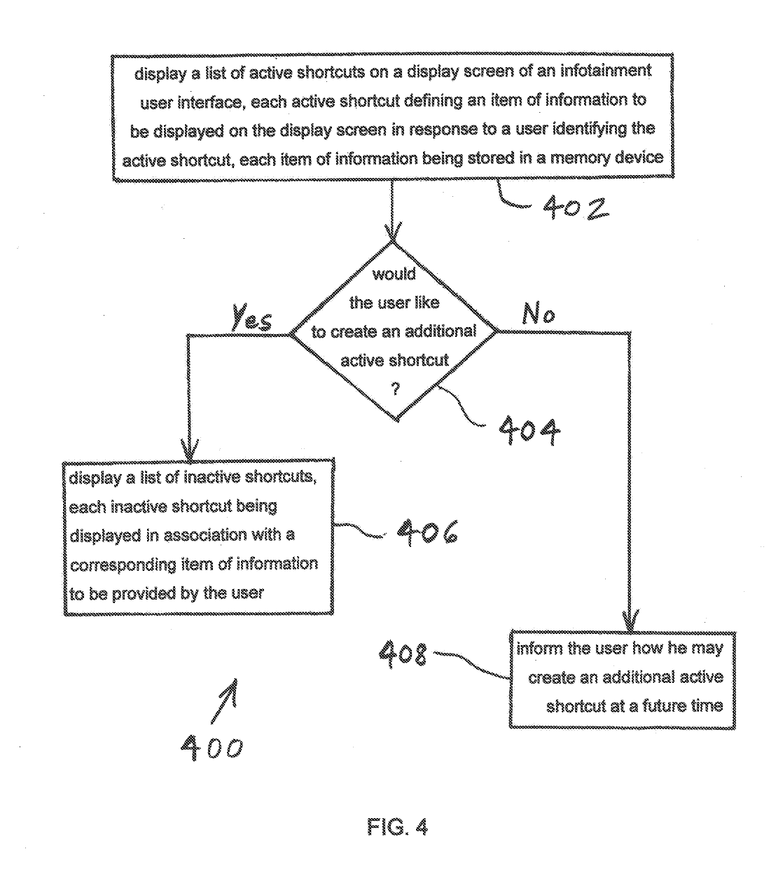

FIG. 4 illustrates yet another embodiment of a method 400 of the present invention for operating an infotainment system of a vehicle. In a first step 402, a list of active shortcuts is displayed on a display screen of an infotainment user interface. Each active shortcut defines an item of information to be displayed on the display screen in response to a user identifying the active shortcut. Each item of information is stored in a memory device. For example, predefined shortcuts may be presented on display screen 14, such as “myVIN”, which may display the vehicle's identification number; “myModel”, which may display the vehicle's model name; and “myServices”, which may display the online services that the vehicle has subscriptions for, such as Sirius or On Star.

Next, in step 404, the user is prompted to indicate whether he would like to create an additional active shortcut. For example, the user may be asked via on-screen text or an audible message whether he wants to create additional shortcuts.

If it is determined in step 404 that the user would like to create an additional active shortcut, then a list of inactive shortcuts may be displayed in step 406. Each inactive shortcut may be displayed in association with a corresponding item of information to be provided by the user. For example, a template may be presented to the user on the display screen. The template may present a list of shortcut names and the corresponding information that the user would need to input into the system, either orally, by keying in the characters, or by uploading from the user's mobile telephone.

Conversely, if it is determined in step 404 that the user would not like to create an additional active shortcut, then in step 408 the user is informed about how he may create an additional active shortcut at a future time. For example, the user may be informed of pushbuttons that he may press in order to access the template of step 406.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A vehicle, comprising:
a memory device storing information identifying the vehicle;
an infotainment user interface, including:
a display screen;
a physical keyboard or a virtual keyboard; and
an electronic processing device communicatively coupled to the memory device, the electronic processing device being configured to respond to a user keying in a set of predefined characters into the keyboard by displaying on the display screen the information identifying the vehicle.

2. The vehicle of claim 1 wherein the information identifying the vehicle comprises a vehicle identification number.

3. The vehicle of claim 1 wherein the set of predefined characters comprises a first set of predefined characters, the memory device storing second information associated with the vehicle or with a human user of the vehicle, the electronic processing device being configured to respond to a user keying in the second set of predefined characters into the keyboard by displaying on the display screen the second information.

4. The vehicle of claim 3 wherein the second information comprises a service record associated with the vehicle.

5. The vehicle of claim 3 wherein the second information comprises a model name of the vehicle.

6. The vehicle of claim 3 wherein the second information comprises a phone number associated with the user of the vehicle.

7. The vehicle of claim 3 wherein the second information comprises a street address associated with the user of the vehicle.

8. A method of operating an infotainment system of a vehicle, the method comprising:
storing information identifying the vehicle in a memory device;
providing an infotainment user interface, including:
a display screen;
a keyboard; and
an electronic processing device;
communicatively coupling the electronic processing device to the memory device; and
responding to a user keying in a set of predefined characters into the keyboard by displaying on the display screen the information identifying the vehicle.

9. The method of claim 8 wherein the information identifying the vehicle comprises a vehicle identification number.

10. The method of claim 8 wherein the set of predefined characters comprises a first set of predefined characters, the memory device storing second information associated with the vehicle or with a human user of the vehicle, the method further comprising responding to a user keying in the second set of predefined characters into the keyboard by displaying on the display screen the second information.

11. The method of claim 10 wherein the second information comprises a service record associated with the vehicle.

12. The method of claim 10 wherein the second information comprises a model name of the vehicle.

13. The method of claim 10 wherein the second information comprises a phone number associated with the user of the vehicle.

14. The method of claim 10 wherein the second information comprises a street address associated with the user of the vehicle.

15. method of operating an infotainment system of a vehicle, the method comprising:
displaying a list of active shortcuts on a display screen of an infotainment user interface, each said active shortcut defining an item of information to be displayed on the display screen in response to a user identifying the active shortcut, each said item of information being stored in a memory device;
prompting the user to indicate whether he would like to create an additional said active shortcut;
if the user indicates that he would like to create an additional said active shortcut, then displaying a list of inactive shortcuts, each said inactive shortcut being displayed in association with a corresponding item of information to be provided by the user; and
if the user indicates that he would not like to create an additional said active shortcut, then informing the user how he may create an additional said active shortcut at a future time.

16. The method of claim 15 wherein the user is informed that he may create an additional said active shortcut at a future time by simultaneously pressing two pushbuttons of the infotainment user interface.

17. The method of claim 15 further comprising responding to the user selecting an active shortcut by displaying a respective said item of information, the user selecting the active shortcut by keying in a predetermined sequence of characters corresponding to the active shortcut.

18. The method of claim 15 further comprising:
detecting the user selecting an inactive shortcut from the list of inactive shortcuts;
prompting the user to provide the item of information corresponding to the selected inactive shortcut;
receiving from the user the item of information corresponding to the selected inactive shortcut; and
including the selected inactive shortcut in the displayed list of active shortcuts.

19. The method of claim 15 wherein one of the items of information includes information identifying the vehicle.

20. The method of claim 15 wherein one of the items of information includes service records associated with the vehicle.
